(19) United States
(12) Patent Application Publication
(10) Pub. No.: US 2006/0227825 A1
(43) Pub. Date: Oct. 12, 2006

(54) Mode-locked quantum dot laser with controllable gain properties by multiple stacking

(75) Inventors: Alexey Kovsh, Dortmund (DE); Alexey Zhukov, St. Petersburg (RU)

Correspondence Address: BROWN & MICHAELS, PC;400 M & T BANK BUILDING, 118 NORTH TIOGA ST, ITHACA, NY, 14850, US

(73) Assignee: NL-Nanosemiconductor GmbH, Dortmund (DE)

(21) Appl. No.: 11/100,970

(22) Filed: Apr. 7, 2005

(51) Int. Cl. H01S 3/13

(52) U.S. Cl. 372/30

(57) ABSTRACT

The optical gain and the differential gain of a quantum dot gain region in a gain section of a passive or hybrid mode-locked laser is varied by stacking at least two planes of quantum dots. All quantum dot planes are preferably formed by the same fabrication method and under the same fabrication conditions. The number of stacked planes of quantum dots is selected such that the optical gain and the differential gain are both in their optimal range with respect to the optical loss in the laser resonator and to the differential gain in the saturable absorber element. This results in a device with a short pulse width, stable mode-locking, high-power, and temperature-independent operation.

### BACKGROUND OF THE INVENTION

1. Field of the Invention

The present invention relates to a quantum-dot laser and, more particularly, to a mode-locked quantum-dot laser that generates ultra-short light pulses, which can be used in, for example, optical data processing, optical communication, and the generation of an optical clock or a sampling signal.

2. Description of Related Art

A quantum dot is a three-dimensional semiconductor structure which has a size of the order of a de-Broglie wavelength, thereby producing quantization of energy levels of confined electrons and holes. Stranski-Krastanow quantum dots, also known as self-organized quantum dots, have appeared recently as a practical realization of ideal quantum dots.

Using a quantum dot array as the gain region of a semiconductor laser provides very flexible control over characteristics of laser gain by adjusting the parameters of a quantum dot array. Controllable laser characteristics include, but are not limited to, the transparency current density (i.e. the pump level at which the population inversion is achieved), the saturated gain (i.e. the maximum available optical gain), the gain bandwidth, and the emission wavelength. Controlling parameters of a quantum dot array include, but are not limited to, the size of the quantum dots, the number of quantum dot planes, the degree of uniformity of quantum dots throughout one or more planes, the surface density of quantum dots in a plane, and a combination of both the number of quantum dot planes and the surface density of quantum dots in a plane. Optimization of the characteristics of laser gain by controlling the parameters of the quantum dot array depends on for what application the quantum dot laser is being considered.

This method has been implemented for high-power lasers (see, e.g. A. R. Kovsh et al., 3.5 W CW operation of quantum dot laser, Electron. Lett. Vol. 35, N. 14, July 1999, pp. 1161-1 163). In this case, since the typical optical loss in the optical resonator of a high-power laser significantly exceeds the saturated gain of a single quantum dot plane, the use of a very high quantum dot density and/or a very large number of quantum dot layers/planes is preferred. Conversely, low-power low-threshold lasers typically rely on the use of single quantum dots while the quantum dot density is optimized to be rather low (see, e.g., G. Park et al., Low-Threshold Oxide-Confined 1.3-μm Quantum-Dot Laser, IEEE Photon. Technol. Lett. Vol. 13, N. 3, March 2000, pp. 230-232). In U.S. Patent Publication No. 2004/0009681, a method is disclosed with respect to a tunable quantum dot laser, which requires a possible broad wavelength range of tunability. Other examples can be found in U.S. Pat. No. 6,816,525 and in A. E. Zhukov, et al. (Control of the emission wavelength of self-organized quantum dots: main achievements and present status, Semicond. Sci. Technol. Vol. 14, N. 6, April 1999, pp. 575-581), where methods are disclosed with respect to highly-strained quantum dots intended for a long-wavelength light source in an optical fiber communication system.

None of the aforementioned prior art optimizes the laser gain characteristics of a quantum dot laser as a mode-locked laser. Mode-locked semiconductor lasers are well suited to a variety of applications such as optical data processing, optical communication, generating optical clock or sampling signals, and other applications that require a source of ultrashort optical pulses with high repetition rates.

Mode-locked lasers are known in the art. For example, Huang et al (Passive mode-locking in 1.3 μm two-section InAs quantum dot lasers, Appl. Phys. Lett. Vol. 78, N. 19, May 2001, pp. 2825-2827) discuss quantum dot lasers with two layers of Stranski-Krastanow quantum dots for passive mode-locking. Thompson et al. (10 GHz hybrid modelocking of monolithic InGaAs quantum dot lasers, IEE Electron. Lett. Vol. 39, N. 15, July 2003, pp. 1121-1122) disclose quantum dot lasers with three layers of Stranski-Krastanow quantum dots for passive and hybrid mode-locking. Thompson et al. (Transform-limited optical pulses from 18 GHz monolithic modelocked quantum dot lasers operating at 1.3 μm, IEE Electron. Lett. Vol. 40, N. 5, March 2004, pp. 346-347) use quantum dot lasers with ten layers of Stranski-Krastanow quantum dots for passive mode-locking. Nambu (U.S. Pat. No. 6,031,859) discloses several layers of quantum dots with discrete gain peaks at frequency periods of integer powers of the reciprocal of the round-trip time in a mode-locked laser to stabilize the mode-locking regime and achieve low jitter. McInerney et al. (U.S. Patent Publication No. 2005/0008048), discuss the use of quantum dots with a broad distribution of the emission wavelengths in a mode-locked laser to achieve automatic matching of the gain spectrum with the cavity resonance and also to achieve low jitter.

None of the prior art for mode-locked lasers optimizes the laser gain characteristics in a mode-locked quantum dot laser to improve important device parameters such as differential efficiency, threshold current density, temperature stability of operating current, and pulse width.

Thus, the above-described quantum dot lasers and mode-locked quantum dot lasers of the prior art have the following drawbacks. When the device parameters of a diode laser (such as differential efficiency, threshold current density, and temperature stability) are optimized by appropriate control of the laser gain by adjusting the parameters of a quantum dot array, the possible mode-locked operation of a quantum dot laser is not considered. Conversely, when the device parameters of a mode-locked laser (such as jitter and stability of mode-locking) are optimized by appropriate control of the laser gain by adjusting the parameters of a quantum dot array, optimization of other important device parameters such as differential efficiency, threshold current density, temperature stability of operating current, and pulse width are sacrificed.

These problems need to be solved for mode-locked quantum dot lasers to become a source of ultrashort optical pulses with high repetition rate for data processing, optical communication, and generation of an optical clock or sampling signal.

Therefore, there is a need in the art for a laser with short pulse width, stable mode-locking, high-power, and temperature-independent operation.

### SUMMARY OF THE INVENTION

The present invention optimizes the parameters of a quantum dot array in the gain section of a mode-locked laser such that the optical gain and the differential gain of the quantum dot gain region are both in their optimal range with respect to the optical loss in the optical resonator and with respect to the differential gain in the saturable absorber element.

A device that generates a sequence of optical pulses includes a quantum dot laser. The parameters of a quantum dot array are adjusted such that the characteristics of the laser gain are most suitable for operating the quantum dot laser as a passive or hybrid mode-locked laser with a short pulse width and high stability of mode-locking while simultaneously holding other device parameters in an optimal range. Some specific optimal parameters include, but are not limited to, low threshold current density, high differential efficiency, high power, and high temperature stability of the operating current.

The device includes a semiconductor laser with a gain section that has a semiconductor gain region formed by multiple stacking of at least two planes of quantum dots. All quantum dot planes are preferably formed by the same fabrication method and under the same fabrication conditions. The device also includes a saturable absorber element optically coupled with the laser in a single optical resonator and drive circuitry connected to the quantum dot laser and the saturable absorber element for operating the quantum dot laser as a passive or hybrid mode-locked laser. Under appropriate driving conditions, the generated sequence of optical pulses is characterized by an average output power greater than 0.5 mW and a pulsewidth of less than approximately 15 ps in the 20-70° C. temperature range.

By selecting the number of quantum dot planes in the laser gain region, it is possible to gradually control the dependence of the optical gain on the carrier density in the laser gain region. Therefore, the relationship between the optical loss in the optical resonator and the saturated gain of the quantum dot gain region may be preselected at will, while other design parameters affecting the optical loss (e.g. laser cavity length and mirror reflectivities) remain unchanged. In one preferred embodiment, the semiconductor gain region is formed by multiple stacking of at least five planes of quantum dots. In another embodiment, the number of quantum dot planes is less than 20.

### BRIEF DESCRIPTION OF THE DRAWINGS

FIG. 1 shows schematic dependence of the optical gain and the differential gain on carrier density in the gain region of a quantum dot laser.

FIG. 2 shows how an increase in the number of quantum dot planes may improve the gain parameters of the laser gain region for mode-locking.

FIG. 3 shows how a decrease in the number of quantum dot planes may improve the gain parameters of the laser gain region for mode-locking.

FIG. 4 illustrates elements of a device for generating an optical pulse sequence.

FIG. 5 is a schematic representation of a passive mode-locked split-contact Fabry-Perot diode laser with the gain region formed by stacking several identical planes of quantum dots.

FIG. 6 shows an alternative embodiment of a laser of the present invention.

### DETAILED DESCRIPTION OF THE INVENTION

A method of the present invention optimizes the parameters of a quantum dot array in the gain section of a mode-locked laser such that the optical gain and the differential gain of the quantum dot gain region are both in their optimal range with respect to the optical loss in the optical resonator and with respect to the differential gain in the saturable absorber element. In a monolithic device, the optical resonator is equivalent to the laser cavity. But in other devices, the optical resonator and the laser cavity are different elements. Additional elements may also be coupled to the optical resonator, as discussed in further detail below.

A device that generates a sequence of optical pulses includes a quantum dot laser. The parameters of a quantum dot array are adjusted such that the characteristics of the laser gain are most suitable for operating the quantum dot laser as a passive or hybrid mode-locked laser with a short pulse width and high stability of mode-locking while simultaneously holding other device parameters in an optimal range. Some specific optimal parameters include, but are not limited to, low threshold current density, high differential efficiency, high power, and high temperature stability of the operating current.

The device includes a semiconductor laser with a gain section that has a semiconductor gain region formed by multiple stacking of at least two planes of quantum dots. All quantum dot planes are preferably nearly identical to each other in terms of quantum dot size, density and other parameters affecting the gain characteristics. Therefore, the optical gain and the differential gain of the quantum dot gain region may be predictably varied by varying the number of planes. Preferably, all quantum dot planes are formed by the same fabrication method and under the same fabrication conditions. The Stranski-Krastanow method, a growing method that uses the change in growth mode from two-dimensional growth to three-dimensional growth when growing a strained semiconductor layer, is preferably used for quantum dot formation. In this case the identity of fabrication conditions for all quantum dot planes, include, but are not limited to, the same growth temperature, atomic fluxes, chemical composition and effective thickness of the deposited materials.

The device also includes a saturable absorber element optically coupled with the semiconductor laser in a single optical resonator and drive circuitry connected to the quantum dot laser and the saturable absorber element for operating the quantum dot laser as a passive or hybrid mode-locked laser. Under appropriate driving conditions, the generated sequence of optical pulses is characterized by an average output power greater than 0.5 mW and a pulsewidth of less than approximately 15 ps in the 20-70° C. temperature range.

By selecting the number of quantum dot planes in the laser gain region, it is possible to gradually control the dependence of the optical gain on the carrier density in the laser gain region. Therefore, the relationship between the optical loss in the optical resonator and the saturated gain of the quantum dot gain region may be preselected at will, while other design parameters affecting the optical loss (e.g. laser cavity length and mirror reflectivities) remain unchanged. In one preferred embodiment, the semiconductor gain region is formed by multiple stacking of at least five planes of quantum dots. In another embodiment, the number of quantum dot planes is less than 20.

For a given optical loss in the optical resonator, the number of quantum dot planes in the laser gain region is preferably selected such that the differential gain and the saturated gain in the laser gain region are both optimized within possible limits to simultaneously achieve low differential gain and high saturated gain.

Since the differential gain is optimized to be sufficiently low, the ratio of gain to absorber saturation energies (which is inversely proportional to the differential gain in the gain section) is sufficiently high, thereby providing stable mode-locking rather than Q-switching and pulse shortening.

Since the saturated gain is simultaneously optimized to be sufficiently high, the ratio of the optical loss to the saturated gain (which affects the threshold current density, internal loss, and temperature stability of a quantum dot laser) is sufficiently low, thereby providing low-threshold, high-efficient, high-power, and temperature stable operation.

Since other design parameters are preferably selected independently of the laser gain region, they are selected in such a manner to be most suitable for the prospective application of the device, which includes the mode-locked quantum dot laser. For example, the total length of the laser cavity is preferably selected to satisfy the required pulse repetition frequency. The reflectivities and construction of the cavity mirrors (laser facets) are preferably selected to satisfy the requirements of coupling of the laser output. The saturable absorber element is either separated from the gain section or integrated with the gain section in a single monolithic chip.

In addition to the gain section and the saturable absorber element, the device optionally includes other elements optically coupled to the optical resonator. For example, a tunable distributed Bragg reflector element is preferably included to restrict the frequency bandwidth and to continuously control oscillation wavelengths, a phase control element is preferably used to continuously tune a repetition frequency, and an RF modulator element is preferably used to perform hybrid mode-locking.

The device provides flexibility and freedom in design. It also provides stable passive or hybrid mode-locking as well as short pulses which are achieved simultaneously with the optimization of other important device parameters, such as high output power and high temperature stability.

An important parameter for passive or hybrid mode-locked lasers is sigma (a), the ratio of gain to absorber saturation energies, σ=Eₛₐₜ^{gain}/Eₛₐₜ^{abs}. Saturation energy is controlled by the differential gain in the gain element or in the saturated absorber. The saturation energy of the laser gain section, Eₛₐₜ^{gain}, and the saturation energy of the absorber section, Eₛₐₜ^{abs}, are given by: Eₛₐₜ=hv A/(Γ dg/dn), where A is the gain or absorber region cross section, hv is the photon energy, Γ is the confinement factor, and dg/dn is the differential gain in the gain or absorber sections, respectively. For stable mode locking (rather than Q-switching), σ should be greater than or equal to 2. Pulse shortening effects are enhanced for higher values of sigma. This can be achieved due to the difference in differential gain (dg/dn) between the absorber and gain sections.

Due to the pronounced effect of gain saturation in a quantum dot gain region, the differential gain (dg/dn) in the gain section may be very low, thereby increasing sigma. On the other hand, operation in the gain saturation regime results in degradation of other laser parameters (e.g. threshold current density and characteristic temperature).

The threshold current density and differential gain in the gain section are both controlled by the relationship between the optical loss in the optical resonator and the saturated gain. If the optical loss is low compared to the saturated gain, low values of threshold current density and high values of characteristic temperature are achieved, while (dg/dn) is rather high. In contrast, if the optical loss is close to the saturated gain, then low values of (dg/dn) are achieved (as preferred for mode-locking) at the expense of a high threshold current. Although the optimum value of optical loss may be found, this method may result in other device parameters (facet coatings, laser cavity length) being out of optimal range.

By changing the number of quantum dot planes in the laser gain region, it is possible to gradually control the dependence of the optical gain on the carrier concentration thereby providing the optimum relationship between optical loss and saturated gain without affecting other device parameters.

Effect of Gain Parameters of the Quantum Dot Gain Region on Characteristics of Mode-Locked Quantum-Dot Lasers

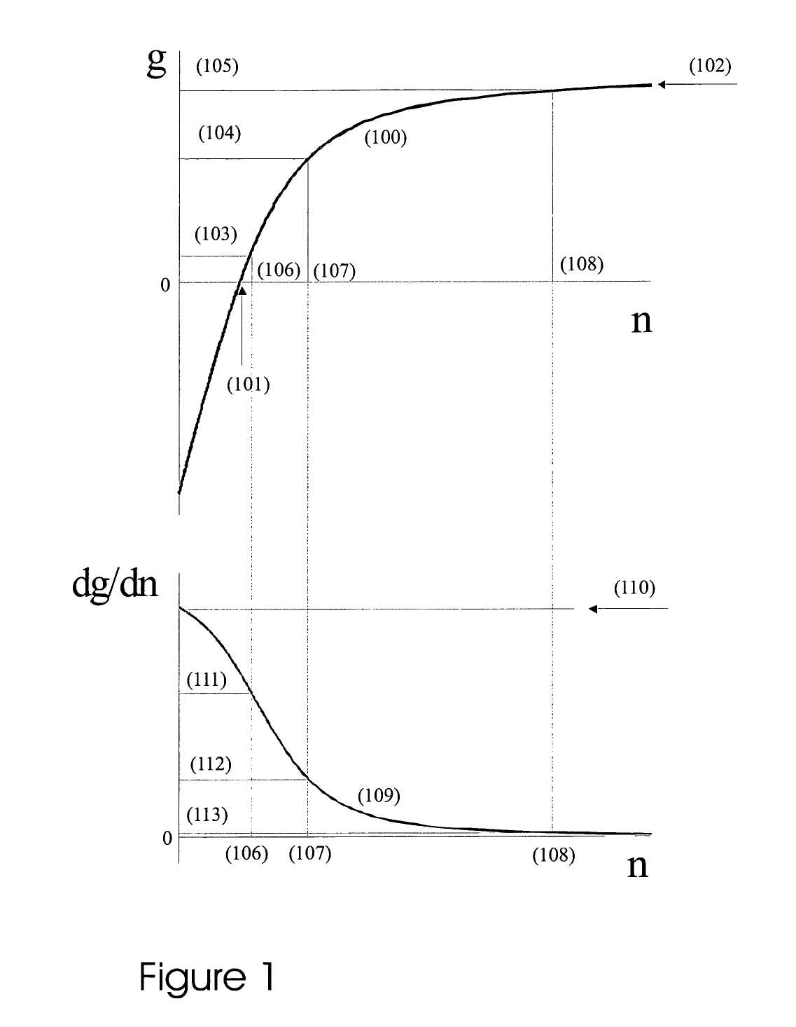

The optical gain (g) (100) is shown in FIG. 1 as a function of the carrier density (n) in the gain region of a gain section of a quantum dot mode-locked laser. A population inversion takes place and the optical gain exactly equals zero as the carrier density equals the transparency carrier density (101). Positive optical gain further increases as the carrier density increases above the transparency carrier density (101) and reaches its maximum value (102), also called the saturated gain.

Horizontal lines (103), (104), and (105) represent different values of optical loss in optical resonators of different designs. The value of the optical loss is varied, for example, by changing the laser cavity length and/or reflectivity of laser mirrors. The intersections of the optical gain (100) with the optical losses from (103) to (105) yield carrier density values at the lasing threshold from (106) to (108). The threshold carrier density can be then directly converted into either a threshold current density if the laser is electrically driven or into a threshold optical power density if the laser is optically driven.

The value of the differential gain (110) in the saturable absorber element of the mode-locked laser is also shown in FIG. 1 together with the differential gain dg/dn (109) in the gain region of the gain section of the quantum dot mode-locked laser. The differential gain (109), which is a derivative of the optical gain (100), decreases with increasing carrier density (n). For the given value of the optical loss from (103) to (105) a certain value of the differential gain from (111) to (113) is achieved.

For the sake of illustration the differential gain (110) in the saturable absorber element is shown to be equal to the maximum value of the differential gain (109) in the gain region of the gain section. This situation occurs if the quantum dot array is used as the gain region of the gain section and simultaneously as the saturable absorber element. However, other situations are also possible and the differential gain (110) may be either higher or lower than the maximum value of the differential gain (109) depending on the design of the saturable absorber element.

As the optical loss increases from (103) to (105), the threshold carrier density increases from (106) to (108), while the differential gain decreases from (111) to (113).

If the optical loss (103) is quite low with respect to the saturated gain (102) (due to a long laser cavity and/or high reflective mirrors), the threshold carrier density (106) is low and close to the transparency carrier density (101). For a quantum dot laser, the transparency carrier density is typically low and temperature independent. Moreover, the internal loss is low because free carrier absorption in the laser cavity is suppressed. Therefore, the laser provides low-threshold, high-efficient, high-power, and temperature-independent operation.

At the same time, if the optical loss (103) is low with respect to the saturated gain (102), the differential gain (111) is high with respect to the differential gain (110) in the saturable absorber element. Therefore, sigma, the ratio of gain to absorber saturation energies, is low, resulting in broad pulse widths and/or unstable mode-locking operation.

In contrast, if the optical loss (105) in a quantum dot laser is quite high with respect to the saturated gain (102), due to a short laser cavity and/or low reflective mirrors, the threshold carrier density (108) is high and far from the transparency carrier density (101). For a quantum dot laser, carriers pile up in the matrix and other materials surrounding the quantum dot array if the carrier density is high, leading to temperature instability and high internal loss. Therefore, the laser provides high-threshold, but low-efficient, low-power, and temperature-unstable operation.

At the same time, if the optical loss (105) is high with respect to the saturated gain (102), the differential gain (113) is low with respect to the differential gain (110) in the saturable absorber element. Therefore, sigma, the ratio of gain to absorber saturation energies, may be high resulting in short pulse width and stable mode-locking operation.

To summarize, if the optical loss (103) in the optical resonator of a quantum dot laser is low with respect to the saturated gain (102), then high-power and temperature-independent operation is achieved, but broad pulse width or unstable mode-locking operation result. In contrast, if the optical loss (105) is high with respect to the saturated gain (102), then a short pulse width and stable mode-locking operation is achieved but low-power and temperature-unstable operation result.

To optimize all the aforementioned device parameters of a mode-locked quantum-dot laser, the optical loss should be set at its optimum value (104) with respect to the saturated gain (102). The optimum optical loss (104) is found somewhere in between the discussed values of low optical loss (103) and high optical loss (105). In this optimum regime, the threshold carrier density (108) is not too high and still close to the transparency carrier density (101). At the same time, the differential gain (112) is sufficiently low with respect to the differential gain (110) in the saturable absorber element. Therefore, a mode-locked quantum dot laser having the optimum optical loss (104) with respect to the saturated gain (102) simultaneously demonstrates a short pulse width, stable mode-locking, low-threshold, high-efficient, high-power, and temperature-independent operation.

The optimum value of the optical loss (104) with respect to the saturated gain (102) is achieved by changing the laser cavity length and/or laser mirror reflectivities. This method, however, restricts the flexibility and freedom in the design of mode-locked quantum dot laser and, in addition, may bring these design parameters out of their optimal range. For example, a change in the cavity length affects the repetition rate, while a change in the laser mirrors affect the coupling efficiency of the laser output.

Optimizing Gain Parameters of Quantum Dot Gain Region of Mode-Locked Quantum-Dot Laser

In accordance with the present invention, the optical loss is set at its optimum value with respect to the saturated gain by changing the dependence of the optical gain on the carrier concentration and by the dependence of the differential gain on the carrier concentration (rather than changing the design of the laser cavity). This method does not restrict the flexibility and the freedom in the design of the mode-locked quantum dot laser and, in addition, allows the design parameters to be kept in their optimal range.

Adjusting the Gain Parameters of a Quantum Dot Gain Region for Optimization of a Quantum Dot Mode-Locked Laser

The optical gain and the differential gain both depend on the density of states in a quantum dot array. Manipulating the density of state one may modify both these gain parameters and bring them to their optimum values for a given optical loss in the device. In general, the density of states of the quantum dot array may be modified either by changing the distribution of energy states or by changing the total surface density of quantum dots.

Manipulation of the energy states distribution means that quantum dot arrays with a higher or lower degree of uniformity may be fabricated at will. Uniformity of the quantum dot array includes not only uniformity of dimensions of quantum dots throughout the array, but also uniformity of the chemical composition, shape, strain and other parameters affecting the energy of the quantum state in a quantum dot. Therefore, this objective could not be realized by prior art methods of quantum dot formation.

A more realistic method for modification of density of states of quantum dot array is one based on changing the total surface density of quantum dots in the array. The total surface density of quantum dots in the array (which is equal to the total number of quantum dots divided by the area of the device) may be varied either by making the in-plane distribution of quantum dots more or less dense, or by stacking several planes of quantum dots. However, the density of in-plane distribution of quantum dots is very difficult to change in a wide range by prior art methods of quantum dot formation.

In contrast, the number of stacked planes of quantum dots may be widely varied using existing methods of quantum dot formation. If all quantum dot planes are formed by the same fabrication method and under the same fabrication conditions, the density of state of the quantum dot array is increased with a constant increment each time an additional quantum dot plane is formed. Accordingly, the optical gain and the differential gain of the quantum dot gain region may be modified in a preselected manner by optimizing the number of fabricated planes of quantum dots.

In accordance with the method of the present invention, the optical gain and the differential gain of the quantum dot gain region of the gain section of mode-locked quantum dot laser is varied by stacking at least two planes of quantum dots. All quantum dot planes are preferably formed by the same fabrication method and under the same fabrication conditions. In one embodiment, there are at least five planes of quantum dots. In another embodiment, there are 20 planes or less. In yet another embodiment, there are five to twenty planes of quantum dots.

The number of stacked planes of quantum dots is selected such that the optical gain and the differential gain of the quantum dot gain region are both in their optimal range with respect to the optical loss in the optical resonator and to the differential gain in the saturable absorber element. This creates a short pulse width, stable mode-locking, low-threshold, high-efficient, high-power laser with temperature-independent operation.

While it may appear that similar methods could be used in order to optimize mode-locked quantum well lasers by optimizing the number of quantum wells, single quantum wells provide too high a density of states. Therefore, the variation of the density of states and, accordingly, the variation of the optical gain and the differential gain by changing the number of quantum wells is too high. Therefore, fine optimization of the laser parameters is not possible.

Quantum dots, in contrast, are very favorable for the realization of the method of the present invention because the density of states which corresponds to one plane of quantum dots can be quite low. Typically, the density of states in a single plane of self-organized quantum dots is about one order of magnitude lower than the density of states in a single quantum well. Thus, by varying the number of quantum dot planes, the gain parameters of a quantum dot laser may be optimized much more precisely.

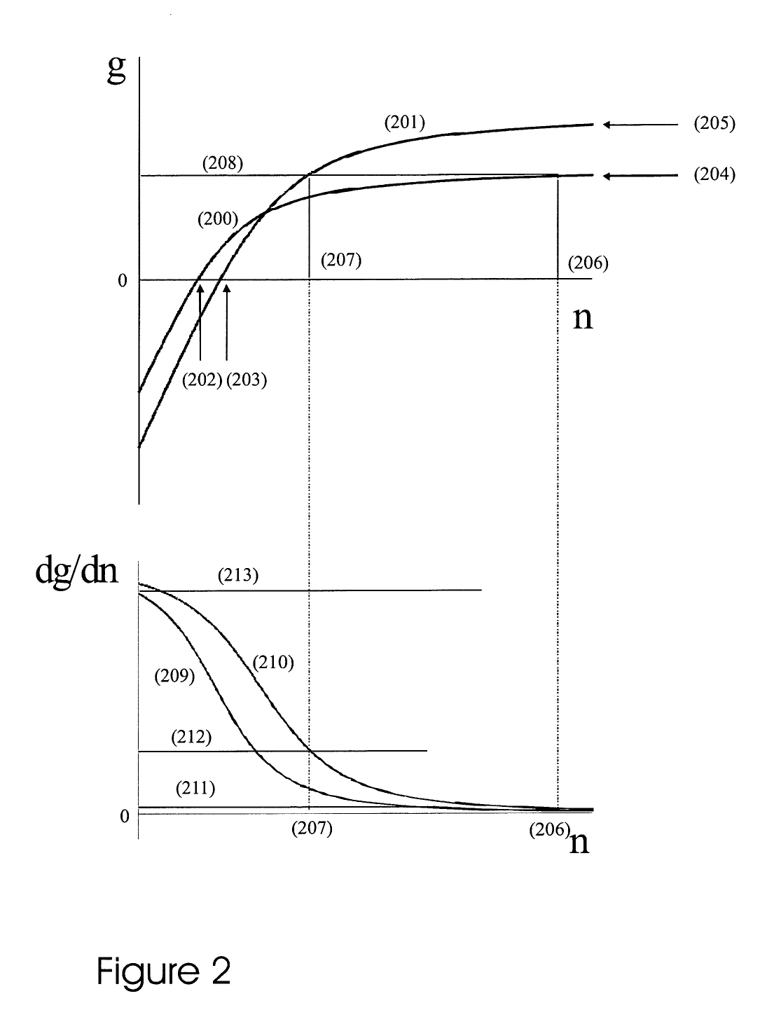

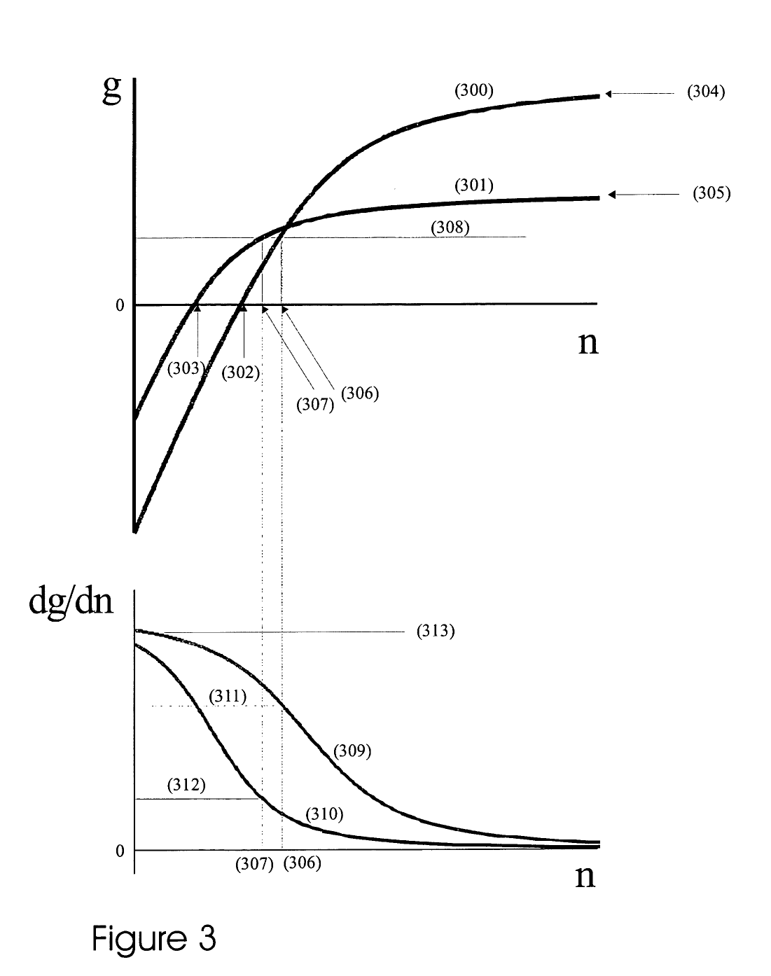

FIGS. 2 and 3 illustrate how varying the number of quantum dot planes may bring the gain parameters of the laser gain region to their optimum values.

FIG. 2 shows how an increase in the number of quantum dot planes improves the gain parameters of the laser gain region for mode-locking. The optical gain (g) (200) and the differential gain (209) for the initial array of quantum dots are shown as function of the carrier density (n). The figure shows that the optical loss (208) in the optical resonator is quite close to the saturated gain (204) of the initial array. Although the differential gain (211) of the initial array is quite low with respect to the differential gain (213) in the saturable absorber section, the threshold carrier density (206) is too high, which is unfavorable for a mode-locked laser.

The modified array of quantum dots has a larger number of quantum dot planes than the initial array. Accordingly, the transparency carrier density (203) and the saturated gain (205) of the modified array are proportionally larger than the transparency carrier density (202) and the saturated gain (204) of the initial array, which has less quantum dot planes. As a result, the optical gain (201) and the differential gain (210) of the modified array shown as a function of carrier density are both modified with respect to those characteristics of the initial array.

The number of quantum dot planes is modified in such a manner that the saturated gain (205) is now sufficiently high with respect to the optical loss (208) in the optical resonator. A significant reduction of the threshold carrier density (207) results while the differential gain (212) is still sufficiently low with respect to the differential gain (213) in the saturable absorber section. All these features are favorable for a mode-locked laser. A short pulse width, stable mode-locking, low-threshold, high-efficient, high-power, and temperature-independent operation all result.

FIG. 3 shows another embodiment in which a decrease in number of quantum dot planes improves the gain parameters of the laser gain region for mode-locking. The optical gain (g) (300) and the differential gain (309) for the initial array of quantum dots are shown as a function of the carrier density (n). In this embodiment, the optical loss (308) in the optical resonator is quite low with respect to the saturated gain (304) of the initial array. Although the threshold carrier density (306) is quite low and close to the transparency carrier density (302), the differential gain (311) of the initial array is high and comparable with the differential gain (313) in the saturable absorber section, which results in a low value of sigma and is thus unfavorable for a mode-locked laser.

The modified array of quantum dots has less quantum dot planes compared to the initial array. Accordingly, the transparency carrier density (303) and the saturated gain (305) of the modified array is proportionally lower than the transparency carrier density (302) and the saturated gain (304) of the initial array, which has a larger number of quantum dot planes. As a result, the optical gain (301) and the differential gain (310) of the modified array shown as a function of carrier density are both modified compared to those characteristics of the initial array.

The number of quantum dot planes is modified in such a manner that the differential gain (312) is now sufficiently low with respect to the differential gain (313) in the saturable absorber section, which results in a high value of sigma. At the same time, the threshold carrier density (307) in the modified array is still quite low compared to the initial threshold carrier density (306) of the initial quantum dot array. Both these features are favorable for mode-locked lasers. A short pulse width, stable mode-locking, low-threshold, high-efficient, high-power, and temperature-independent operation results.

The method described herein is applicable to any quantum dot array regardless of the in-plane distribution of quantum dots. The in-plane distribution may be either broad or narrow. All planes of quantum dots of the multiple stacked array are preferably fabricated by the same fabrication method and under the same fabrication conditions. This ensures the identity of gain parameters for each quantum dot plane, thereby providing controllable modification of gain parameters in the resulting multiple stacked array of quantum dots. In one embodiment, the quantum dots are fabricated in an epitaxial process in a lattice-mismatched material system. In this embodiment, the quantum dots are preferably fabricated on a GaAs or an InP substrate, and are preferably embodied in an InGaAs material system.

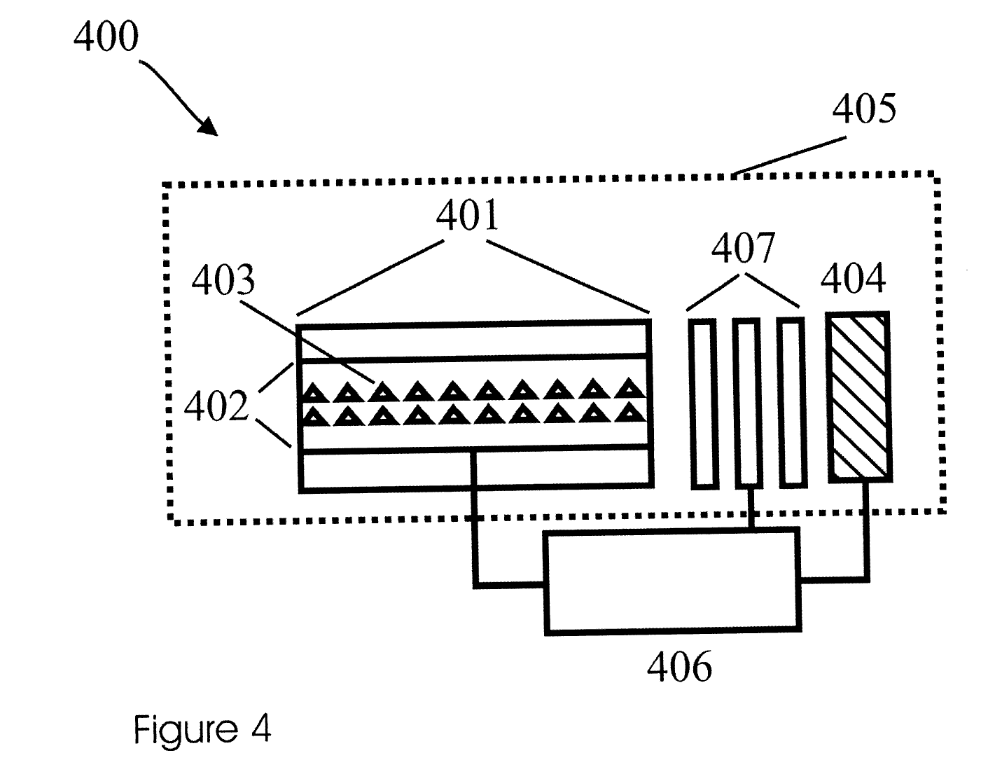

FIG. 4 illustrates, in a block diagram, a device (400) for generating a sequence of optical pulses. The device includes the following essential elements:

a) a semiconductor laser (401) including a gain section (402) with a semiconductor gain region (403) formed by multiple stacking of several planes of quantum dots;

b) a saturable absorber element (404) optically coupled with the semiconductor laser (401) in a single optical resonator (405); and

c) drive circuitry (406) connected to the semiconductor laser (401) and the saturable absorber element (404).

The number of quantum dot planes in the laser gain region (403) is preselected in accordance with the method of the present invention such that the optical gain and the differential gain are both in their optimal range with respect to the optical loss in the optical resonator (405) and with respect to the differential gain in the saturable absorber element (404).

The drive circuitry (406) operates the semiconductor laser (401) optically coupled to the saturable absorber element (404) as a mode-locked laser. Under appropriate driving conditions, the device (400) generates a sequence of optical pulses which are characterized by an average output power greater than 0.5 mW and a pulsewidth of less than approximately 15 ps in a temperature range of 20-70° C.

In addition to the gain section (402) of the semiconductor laser (401) and the saturable absorber element (404), the device (400) optionally includes one or more additional elements (407) optically coupled with the semiconductor laser (401) and the saturable absorber element in a single optical resonator (405). For example, an RF modulator element is preferably used to perform hybrid mode-locking, a tunable distributed Bragg reflector element is preferably included to restrict the frequency bandwidth and to continuously control oscillation wavelengths, and a phase control element is preferably used to continuously tune a repetition frequency.

Some of these additional elements (407) are connected to the drive circuitry (406) to realize their functionality. For example, the RF modulator element is driven by both a negative bias and a radio-frequency signal with a frequency coinciding with the repetition frequency of the optical pulse sequence of the optical resonator to stabilize the mode-locking regime and reduce jitter. The tunable distributed Bragg reflector element is driven by a DC current which controls the carrier density in the element. As a result, a refractive index changes, and thus the Bragg wavelength shifts. Similarly, a repetition frequency is controlled within certain limits by a DC current applied to the phase control element.

The method described herein is applicable to a wide variety of constructions. For example, the saturable absorber element (404) is either separated from the gain section (401) or integrated with the gain section (401) in a single monolithic chip. Also, the optical resonator (405) is either an external resonator or a monolithic cavity including all of the elements of the device. Preferably, all the elements are monolithically integrated in a single monolithic chip.

An unpumped quantum dot region provides bleachable optical loss. Therefore, in a preferred embodiment, it is used as a saturable absorber element of the mode-locked semiconductor laser. A quantum-dot-based saturable absorber operates under such conditions that the carrier density is very close to zero. As seen in FIG. 2, near this point the differential gain is essentially independent of the number of quantum dot planes used. Therefore, the number of planes in a quantum dot array does not affect the characteristics of the saturable absorber element. Thus, the same quantum dot array formed by multiple stacking of several planes of quantum dots may be simultaneously used as the gain region in the gain section and in the saturable absorber element of a mode-locked laser. The number of planes is selected in accordance with the previously discussed principles of optimization of the quantum-dot-based gain section.

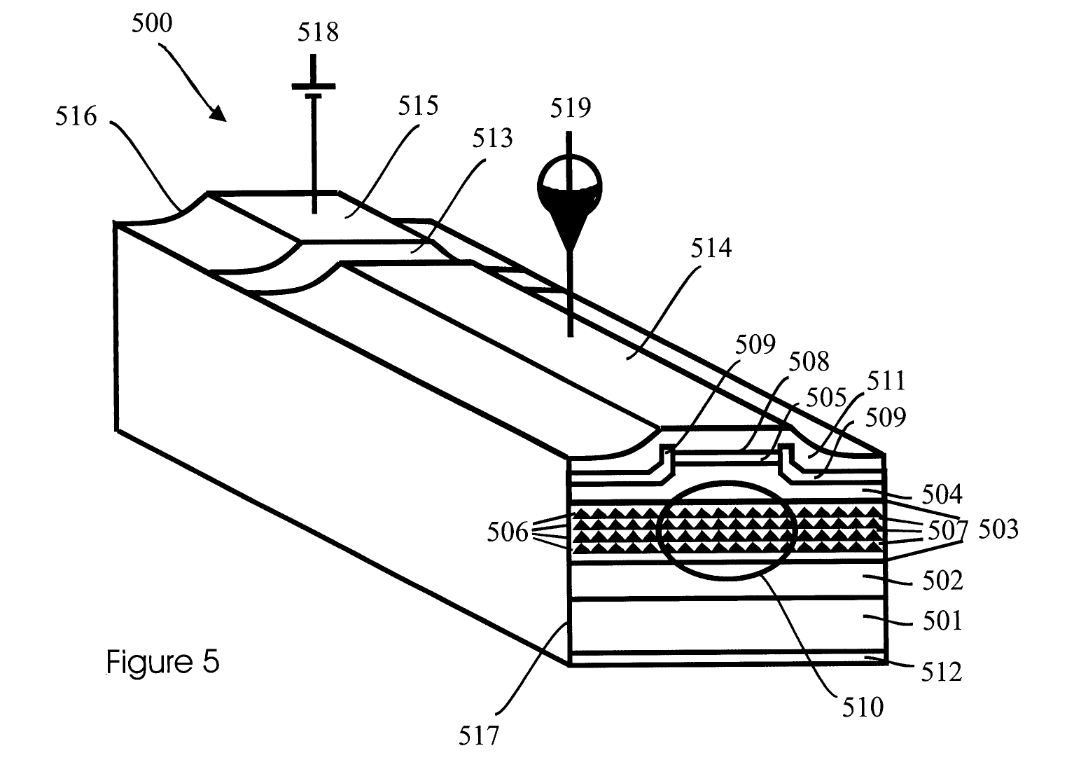

In one embodiment of the present invention, a device for generating a sequence of optical pulses includes a quantum dot mode-locked laser constructed as a passive mode-locked split-contact Fabry-Perot diode laser (500) as shown in FIG. 5.

A layered structure is epitaxially grown on a substrate (501). The substrate (501) is preferably a n+ doped GaAs substrate. The layered structure includes, in order, a first cladding layer (502), a waveguiding layer (503), a second cladding layer (504), and a contact layer (505). The waveguiding layer (503) also acts as a matrix where the quantum dot array is embedded. In an example with an n+ doped GaAs substrate, the layers are preferably a n-AlGaAs layer (502), a GaAs layer (503), a p-AlGaAs layer (504), and a p+ GaAs layer (505).

A quantum dot array is formed by the successive deposition of several planes (506) of quantum dots separated by spacer layers (507) of the matrix material. Each spacer layer preferably has equal thickness. Each quantum dot plane preferably represents a plane of Stranski-Krastanow self-organized quantum dots embodied in an InGaAs material system. Each plane (506) is preferably deposited under the same growth conditions.

Alternatively, other material systems may be used for the self-organized quantum dots (506), the matrix (503), and the laser structure (500) as a whole. Some examples for the quantum dot (506)/matrix (503) combination include, but are not limited to, a) InGaAs/GaAs, InGaAs/AlGaAs, InAlAs/AlGaAs, InP/InGaP, or InAs/InGaAs on GaAs substrates; b) InAs/InGaAs, InAs/InAlAs, or InAs/InP on InP substrates; and c) GaInP/GaP, InAs/GaP, or InP/GaP on GaP substrates. In general, any thin film having a sufficient mismatch of lattice constant with respect to the matrix layer (503) tends to transform into an array of self-organized islands. Provided that the bandgap of this material is narrower than the bandgap of the surrounding matrix, this array may be considered an array of quantum dots.

The second cladding layer (504) and the contact layer (505) are preferably processed into a longitudinal ridge structure (508) with side walls protected by a dielectric film (509). The ridge structure (508) localizes the light generation to a central zone (510) of the laser gain region. An optical resonator is defined by cleaved facets (516) and (517) which can optionally be coated with high reflective or low reflective dielectric structures.

An n-ohmic contact (512) is formed on the back side of the substrate (501). A p-ohmic contact formed on top of the GaAs contact layer (505) is split into a first section (514) and a second section (515) by an isolating mesa (513) etched through the contact layer (505) and the top part of the second cladding layer (504). Ohmic contacts are fabricated by methods well-known by those skilled in the art. Metals are selected in accordance with the semiconductor material of the substrate (501) and the topmost layer (505). AuGe/Au (or AuGe/Ni/Au) and AuZn/Au (or Ti/Pt/Au, or Cr/Au) are preferably used in a GaAs-based laser structure for the n- and p-ohmic contacts, respectively.

During use, a suitable forward current provided by a DC source (519) is applied to the first section (514) to cause laser light generation. A suitable negative bias provided by a DC source (518) is applied to the second section (515) to cause absorption of low intensity pulses and propagation of high intensity pulses. Thus, the first section (514) operates as a gain section of a mode-locked laser, the second section (515) operates as a saturable absorber section of a mode-locked laser, and the mode-locked laser (500) operates as a passively mode-locked laser.

Under appropriate driving conditions, self-starting and stable CW modelocking is achieved and the laser generates a sequence of short optical pulses that are useful for optical data processing, optical communication, and the generation of an optical clock or a sampling signal. The output light beam may be coupled to optical fibers or other optical circuits by coupling optical elements (not shown).

In one preferred embodiment, each quantum dot plane (506) is formed by low-temperature deposition of 2.5 monolayers of InAs capped with 5-nm-thick In_{0.15}Ga_{0.85}As. The spacer (507) thickness is preferably 33 nm. The saturated optical gain and the transparency current density for a single plane of quantum dots are preferably approximately 3 cm⁻¹ and 10A/cm², respectively. The wavelength of emission is preferably about 1280 nm.

In this embodiment, the length of the isolating mesa (513) is 20 μm, while the length of the first gain section (514) is 3.8 mm, and the length of the second saturable absorber section (515) is 0.35 mm, making the total length of the optical resonator about 4.1 mm. This results in a pulse repetition frequency of about 10 GHz. The ridge width is 10 μm. The negative bias to the saturable absorber section is 6V, and the forward current to the gain section is 500 mA.

Optical loss in the optical resonator is defined by the output loss determined by the cavity length and facet reflectivities, by internal loss in the laser waveguide and by unbleachable loss in the saturable absorber section. For the above design of the quantum dot mode-locked laser (500), the optical loss in the optical resonator is approximately 8.8 cm⁻¹, the differential gain in the absorber section is approximately 0.19 cm⁻¹/(A/cm²), and the optimum number of quantum dot planes is approximately 5.

A series of mode-locked quantum dot lasers were grown and fabricated in accordance with the design of FIG. 5. Three different lasers, with 3, 5, and 7 quantum dot planes, respectively, were grown. The measured characteristics of the pulse generating device based on the mode-locked quantum dot lasers are listed in Table 1.

TABLE 1
Characteristics of pulse generating device based on mode-locked
quantum dot lasers with varied number of quantum dot planes

| | Pulse width at | | |
|---|---|---|---|
| Number of | 20° C. assuming | Average | Average |
| quantum dot | Lorenzian pulse | light power | light power |
| planes | shape, ps | at 20° C., mW | at 70° C., mW |
| 3 | 3 | 0.05 | No lasing |
| 5 | 4 | 2 | 1.5 |
| 7 | 18 | 2.2 | 1.7 |

The device based on a quantum dot laser with 3 planes of quantum dots produces a sequence of short optical pulses with a pulse width of about 3 ps estimated for the Lorenzian pulse shape. However, the light power is quite low at 20° C. while no lasing is observed at elevated temperature of 70° C. Such a mode-locked laser is characterized by a rather high value of sigma which is favorable for pulse shortening. However, the threshold current density is quite high and strongly temperature dependent due to the low saturated gain of the quantum dot gain region with respect to the optical loss established in the optical resonator, which results in low and strongly temperature dependent power.

The device based on a quantum dot laser with 7 planes of quantum dots provides a sequence of optical pulses with a rather high power of 2.2 mW at room temperature. The power slightly degrades to 1.7 mW at elevated temperature. However, the pulse width has a quite large value of about 18 ps. Such a mode-locked laser is characterized by a rather high value of saturated gain with respect to the optical loss established in the optical resonator (which is favorable for high power and temperature stable output). However, the value of sigma is quite low (which results in pulse broadening).

In contrast to the device with either 3 quantum dot planes or 7 quantum dot planes, the device based on a quantum dot laser with 5 planes of quantum dots simultaneously provides high-power, temperature stable, and short-pulse output. Due to the optimum gain characteristics, the gain region provides both a high value of sigma and a high value of the saturated gain with respect to the optical loss. The output power and its temperature stability (2.2 mW and 1.5 mW at 20° and 70° C., respectively) compares favorably with the same characteristics of a laser based on a larger number of quantum dot planes, while the pulse width (4 ps) compares favorably with the same characteristic of the laser based on a smaller number of quantum dot planes.

Thus, a laser with an optimum number of quantum dot planes has all the advantages and simultaneously avoids the disadvantages of quantum dot lasers with more or less planes.

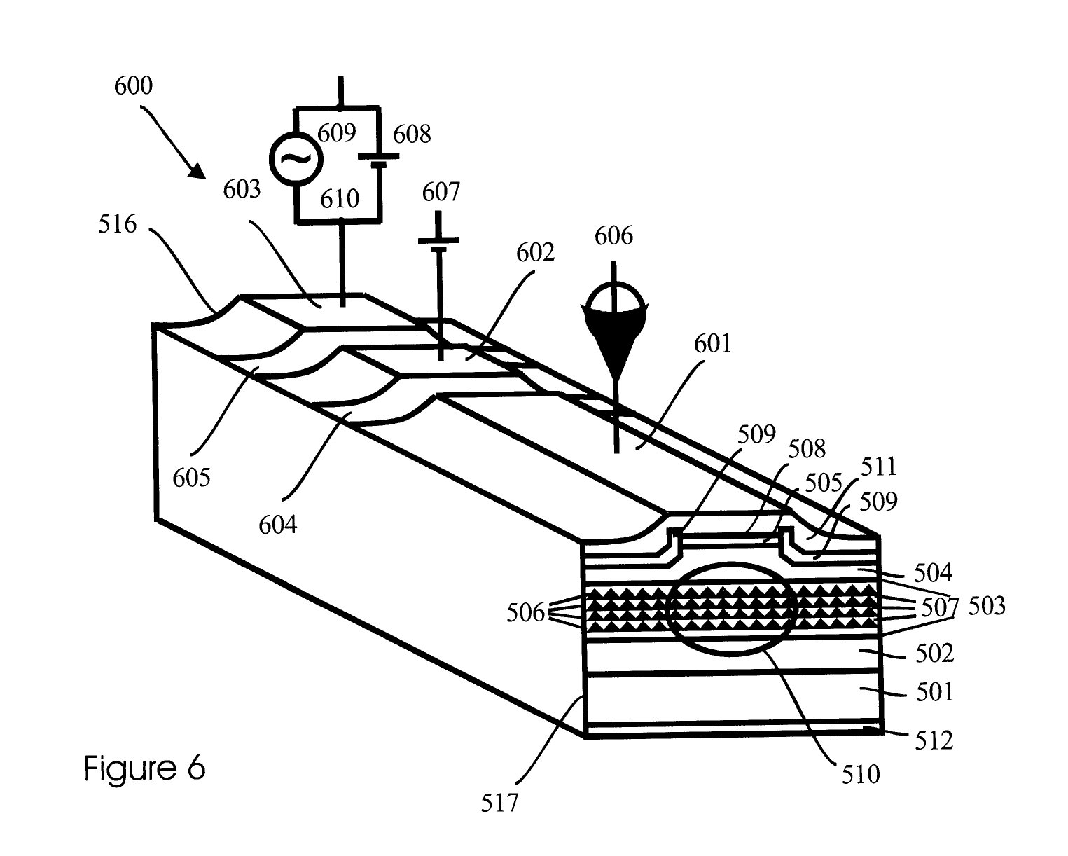

In another embodiment, a quantum dot mode-locked laser (600), as shown in FIG. 6, also includes a third split-contact section separated from the saturable absorber section and the gain section by isolating mesas. A p-ohmic contact formed on top of the GaAs contact layer (505) is split into a first section (601), a second section (602), and a third second section (603) by isolating mesas (604) and (605) etched through the contact layer (505) and the top part of the second cladding layer (504).

During use, a suitable forward current provided by a DC source (606) is applied to the first section (601) to cause laser light generation. A suitable negative bias provided by a DC source (607) is applied to the second section (602) to cause absorption of low intensity pulses and propagation of high intensity pulses. The third section (603) is driven by both a negative bias from a DC source (608) and a radio-frequency signal from a RF source (609) coupled through a bias-tee (610). Other elements not shown in FIG. 6 such as inductors and capacitors may be optionally included for impedance matching. During use, a frequency of the RF signal coincides with the repetition frequency of the optical pulse sequence of the optical resonator to stabilize the mode-locking regime and reduce jitter.

The first section (601) operates as a gain section of a mode-locked laser, the second section (602) operates as a saturable absorber section of a mode-locked laser, and the third section (603) operates as a modulator section. Thus, the mode-locked laser (600) operates as a hybrid mode-locked laser. This embodiment maintains all the advantages of the previously described passive mode-locked quantum dot laser and additionally has lower jitter.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A device for generating a sequence of optical pulses comprising:
a) a semiconductor laser comprising a gain section including a semiconductor gain region formed by multiple stacking of at least two planes of quantum dots;
b) a saturable absorber element optically coupled with the semiconductor laser in a single optical resonator; and
c) a drive circuitry connected to the semiconductor laser and the saturable absorber element, wherein the drive circuitry operates the semiconductor laser as a mode-locked laser;
wherein the sequence of optical pulses has an average output power greater than 0.5 mW and a pulsewidth of less than approximately 15 ps in a temperature range of 20-70° C.

2. The device of claim 1, wherein all of the planes of quantum dots are formed by the same fabrication method and under the same fabrication conditions.

3. The device of claim 1, wherein the mode-locked laser is a passive mode-locked laser.

4. The device of claim 1, wherein the mode-locked laser is a hybrid mode-locked laser.

5. The device of claim 1, wherein the semiconductor gain region is formed by multiple stacking of at least five planes of quantum dots.

6. The device of claim 1, wherein the semiconductor gain region is formed by multiple stacking of five planes of quantum dots.

7. The device of claim 1, wherein the number of planes of quantum dots in the semiconductor gain region is less than or equal to 20 planes.

8. The device of claim 1, wherein the mode-locked laser is a monolithic mode-locked laser.

9. The device of claim 1, wherein the mode-locked laser is an electrically driven laser.

10. The device of claim 9, wherein the electrically driven mode-locked laser is a ridge-waveguide laser.

11. The device of claim 1, wherein the mode-locked laser comprises at least a first contact section and second contact section, wherein the first contact section is a gain section that provides gain under a forward current, and the second contact section is a saturable absorber section that provides mode-locking under a negative bias, such that the mode-locked laser operates as a passive mode-locked laser.

12. The device of claim 1, wherein the mode-locked laser comprises at least a first contact section, a second contact section, and a third contact section, wherein the first contact section is a gain section that provides gain under a forward current, the second contact section is a saturable absorber section that provides mode-locking under a negative bias, and the third contact section stabilizes mode-locking under modulation by a radio frequency signal such that the laser operates as a hybrid mode-locked laser.

13. The device of claim 1, wherein the quantum dots are Stranski-Krastanow self-organized quantum dots.

14. The device of claim 13, wherein the quantum dots are fabricated in an epitaxial process in a lattice-mismatched material system.

15. The device of claim 13, wherein the quantum dots are fabricated on a GaAs substrate.

16. The device of claim 13, wherein the quantum dots are fabricated on an InP substrate.

17. The device of claim 13, wherein the quantum dots are in an InGaAs material system.

18. The device of claim 1, further comprising at least one additional element optically coupled with the semiconductor laser and the saturable absorber element in the optical resonator and connected to the drive circuitry, wherein the additional element is selected from the group consisting of:
a) a tunable distributed Bragg reflector to restrict a frequency bandwidth and to continuously control oscillation wavelengths;
b) a phase control element that continuously tunes a repetition frequency;
c) an RF modulator element to perform hybrid mode-locking; and
d) any combination of a) through c).

19. The device of claim 1, wherein the saturable absorber element comprises an unpumped quantum dot active region.

20. A device for generating a sequence of optical pulses comprising:
a) a semiconductor laser comprising a gain section including a semiconductor gain region formed by multiple stacking of at least two planes of quantum dots;
b) a saturable absorber element optically coupled with the semiconductor laser in an optical resonator; and
c) a drive circuitry connected to the semiconductor laser and the saturable absorber element, wherein the drive circuitry operates the semiconductor laser as a mode-locked laser;
wherein a number of stacked planes of quantum dots is selected such that an optical gain and a differential gain are both in an optimal range with respect to an optical loss in the optical resonator and with respect to a differential gain in the saturable absorber element.

21. The device of claim 20, wherein the sequence of optical pulses has an average output power greater than 0.5 mW and a pulsewidth of less than approximately 15 ps in a temperature range of 20-70° C.

22. The device of claim 20, wherein all of the planes of quantum dots are formed by the same fabrication method and under the same fabrication conditions.
